(19) United States
(12) Patent Application Publication
(10) Pub. No.: US 2016/0100381 A1
(43) Pub. Date: Apr. 7, 2016

(54) SYSTEMS, METHODS, AND DEVICES FOR EFFICIENT INDICATION OF BANDWIDTH AND STREAM ALLOCATION

(71) Applicants: Qinghua Li, San Ramon, CA (US); Xiaogang Chen, Beijing (CN); Yuan Zhu, Beijing (CN); Rongzhen Yang, Shanghai (CN); Xintian E. Lin, Mountain View, CA (US)

(72) Inventors: Qinghua Li, San Ramon, CA (US); Xiaogang Chen, Beijing (CN); Yuan Zhu, Beijing (CN); Rongzhen Yang, Shanghai (CN); Xintian E. Lin, Mountain View, CA (US)

(21) Appl. No.: 14/582,840

(22) Filed: Dec. 24, 2014

Related U.S. Application Data
(60) Provisional application No. 62/061,065, filed on Oct. 7, 2014.

(51) Int. Cl. H04W 72/04

(52) U.S. Cl. CPC H04W 72/042; H04W 84/12

(57) ABSTRACT

Example systems, methods, and devices for efficient indication of bandwidth and stream allocation are discussed. In one embodiment, a method for indication of bandwidth allocation in a wireless network can include partitioning, by a network device, a bandwidth of a wireless signal into a plurality of subband units, assigning one or more switch bits between adjacent subband units, and allocating one or more modified subband units to one or more users of the network. In another embodiment, a method for stream allocation can include partitioning, by a network device, a spatial stream of a wireless signal into a plurality of spatial streams, assigning one or more switch bits between adjacent spatial streams, and allocating one or more modified spatial streams to one or more users of the network. Certain methods, apparatus, and systems described herein can be applied to 802.11ax or any other wireless standard.

### CROSS REFERENCE TO RELATED APPLICATION

This application claims the benefit of U.S. provisional Patent Application Ser. No. 62/061,065, filed on Oct. 7, 2014, the disclosure of which is incorporated herein by reference.

### TECHNICAL FIELD

Embodiments described herein generally relate to wireless networks.

### BACKGROUND

A next generation WLAN, IEEE 802.11ax or High-Efficiency WLAN (HEW), is under development. Uplink multiuser MIMO (UL MU-MIMO) and Orthogonal Frequency-Division Multiple Access (OFDMA) are two major features included in the new standard. For both features, however, the physical layer header is an overhead and reducing its size and reliability is an important aspect.

### BRIEF DESCRIPTION OF THE DRAWINGS

FIG. 1 is a network diagram illustrating an example network environment, according to one or more example embodiments of the disclosure;

FIG. 2 illustrates resource allocation in a physical layer OFDM frame of an IEEE 802.11 ax network, according to one or more example embodiments of the disclosure;

FIG. 3 illustrates serial and parallel transmission of signal field (SIG) information, according to one or more example embodiments of the disclosure;

FIG. 4 illustrates an example bandwidth partition into a plurality of subband units, according to one or more example embodiments of the disclosure;

FIG. 5 illustrates an example stream partition into a plurality of spatial streams, according to one or more example embodiments of the disclosure;

FIG. 6 illustrates an example of stream allocation to a user, according to one or more example embodiments of the disclosure;

FIG. 7 illustrates example operations in a method for use in systems and devices, according to one or more example embodiments of the disclosure;

FIG. 8 illustrates a functional diagram of an example communication station or example access point, according to one or more example embodiments of the disclosure;

FIG. 9 shows a block diagram of an example of a machine upon which any of one or more techniques (e.g., methods) may be performed according to one or more embodiments of the disclosure discussed herein; and

FIG. 10 illustrates example operations in a method for use in systems and devices, according to one or more example embodiments of the disclosure.

### DETAILED DESCRIPTION

Example embodiments described herein provide certain systems, methods, and devices, for indication of bandwidth and spatial stream allocation.

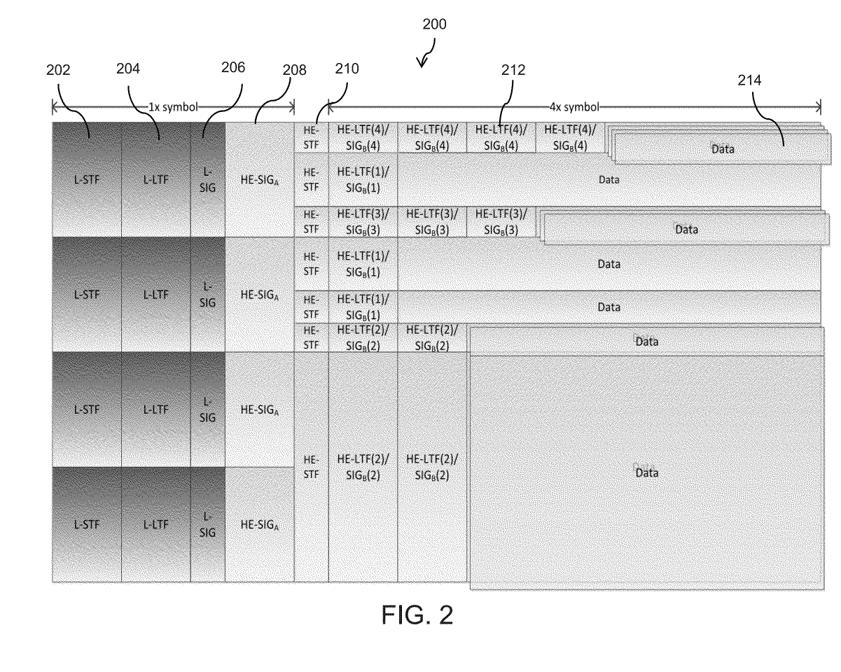

In the current DensiFi discussions, various proposals have been presented for the design of physical layer header, for example, the signal field (SIG). A good design would not only reduce the overhead but also increase the reliability of SIG. The indication of the resource allocation is a responsibility of SIG, providing information about the physical signal format for the user to decode and find his/her data. The resources are distributed in frequency and space and spatial channels as illustrated in FIG. 2, for example. The example physical layer frame format of an OFDM signal 200 illustrated in FIG. 2 may include a legacy portion and a precoded 802.11ax portion, for example. The legacy portion may include legacy short training field (L-STF) 202, legacy long training field (L-LTF) 204, and a legacy signal field (L-SIG) 206, for example. The precoded portion may include a high-efficiency signal field (HE-SIGA) 208, a high-efficiency short training field (HE-STF) 210, a high-efficiency long training field (HE-LTF) 212, and a data field 214, for example. The SIG may usually spend 20-50 bits per user, as illustrated in FIG. 2. Accordingly, it may be desirable to use minimum number of bits to tell the user how to find his/her allocated resource in frequency and space domains.

The systems, methods, and devices described in the present disclosure provide efficient indication techniques that efficiently indicate how the frequency bandwidth may be partitioned and how the spatial streams may be allocated. The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Details of one or more implementations are set forth in the accompanying drawings and in the description below. Further embodiments, features, and aspects will become apparent from the description, the drawings, and the claims. Embodiments set forth in the claims encompass all available equivalents of those claims.

The terms “communication station”, “station”, “handheld device”, “mobile device”, “wireless device” and “user equipment” (UE), as used herein, refer to a wireless communication device such as a cellular telephone, smartphone, tablet, netbook, wireless terminal, laptop computer, a wearable computer device, a femtocell, High Data Rate (HDR) subscriber station, access point, access terminal, or other personal communication system (PCS) device. The device may be either mobile or stationary.

The term “access point” (AP) as used herein may be a fixed station. An access point may also be referred to as an access node, a base station or some other similar terminology known in the art. An access terminal may also be called a mobile station, a user equipment (UE), a wireless communication device or some other similar terminology known in the art. Embodiments disclosed herein generally pertain to wireless networks. Some embodiments c a n relate to wireless networks that operate in accordance with one of the IEEE 802.11 standards including the IEEE 802.11ax standard. Other embodiments can relate to determination of communication status. Further, certain embodiments can relate to channel reservation during communication status determination.

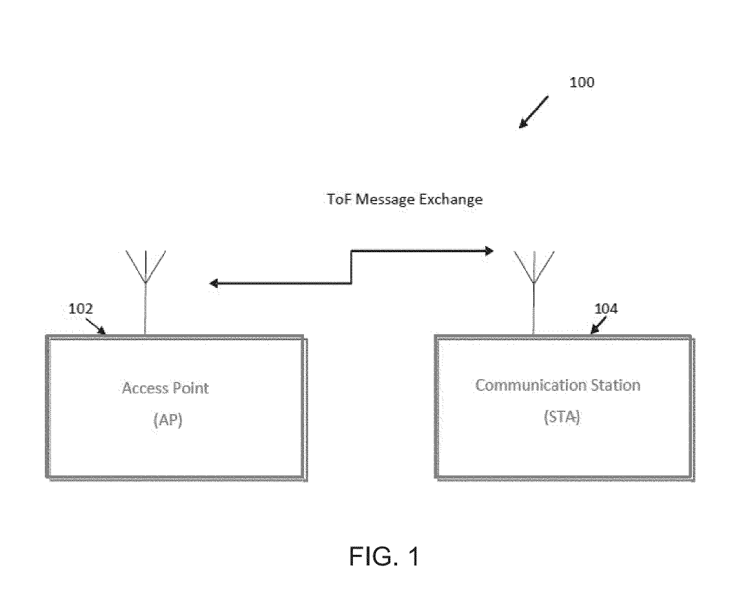

FIG. 1 is a network diagram illustrating an example network environment suitable for FTM Burst Management, according to some example embodiments of the disclosure. Wireless network 100 can include one or more communication stations (STAs) 104 and one or more access points (APs) 102, which may communicate in accordance with IEEE 802.11 communication techniques. The communication stations 104 may be mobile devices that are non-stationary and do not have fixed locations. The one or more APs may be stationary and have fixed locations. The stations may include an AP communication station (AP) 102 and one or more responding communication stations STAs 104.

In accordance with some IEEE 802.11ax (High-Efficiency WLAN (HEW)) embodiments, an access point may operate as a master station which may be arranged to contend for a wireless medium (e.g., during a contention period) to receive exclusive control of the medium for an HEW control period (i.e., a transmission opportunity (TXOP)). The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

The master station may also communicate with legacy stations in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In other embodiments, the links of an HEW frame may be configurable to have the same bandwidth and the bandwidth may be one of 20 MHz, 40 MHz, or 80 MHz contiguous bandwidths or an 80+80 MHz (160 MHz) non-contiguous bandwidth. In certain embodiments, a 320 MHz contiguous bandwidth may be used. In other embodiments, bandwidths of 5 MHz and/or 10 MHz may also be used. In these embodiments, each link of an HEW frame may be configured for transmitting a number of spatial streams.

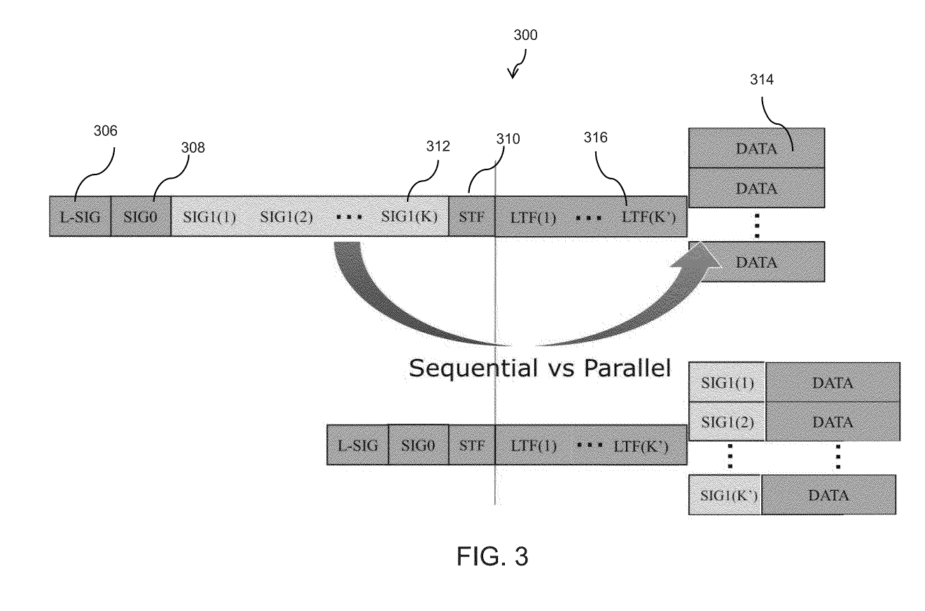

Compared with the existing designs in DensiFi, the disclosed systems, methods, and devices have lower overheads. Example systems, methods, and devices disclosed are beneficial for parallel SIG transmission, as shown in FIG. 3, for example, according to certain embodiments of the disclosure. As illustrated, parallel transmission of SIG information 300, which may include a legacy signal field (L-SIG) 306, a high-efficiency signal field (HE-SIG0) 308, a high-efficiency signal field (HE-SIG#) 312, a high-efficiency short training field (HE-STF) 310, a high-efficiency long training field (HE-LTF) 316, and a data field 314, for example, may result in lower overheads when compared to sequential transmission of SIG information 300.

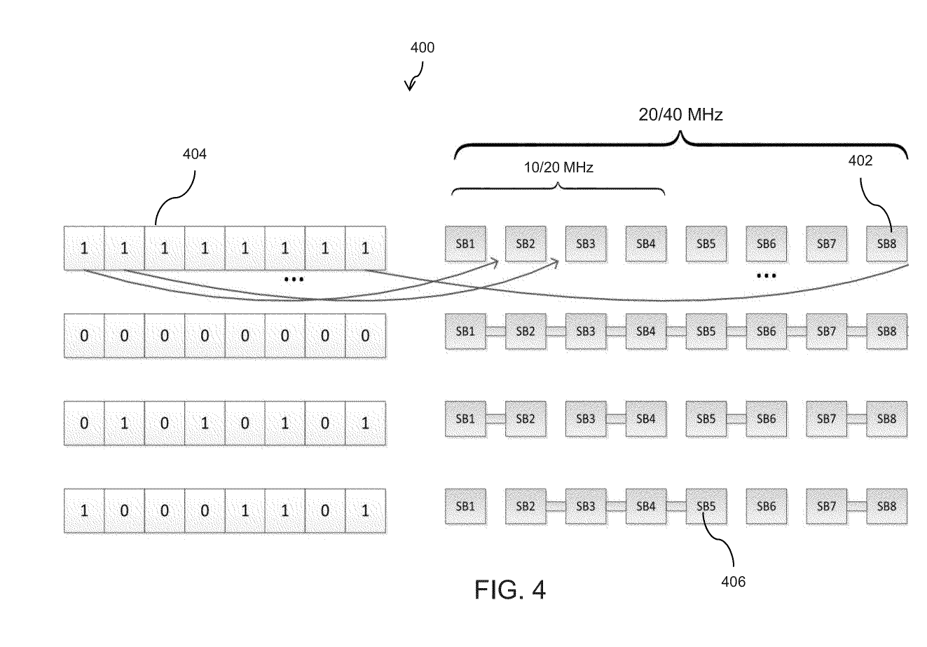

FIG. 4 illustrates an example method for bandwidth allocation in the systems and devices, according to one or more example embodiments of the disclosure. The SIG information 400 may be divided into common part and user specific part, denoted by SIG_{A} (SIG0) and SIG_{B} (SIG1), respectively. A minimum bandwidth unit, as described herein, may be of 20/2^{L} MHz, 40/2^{L} MHz, 80/2^{L} MHz, or 160/2^{L} MHz where L may be a positive integer. For L=2, at 20 MHz the bandwidth unity may be 5 MHz, for example, and for L=3, the bandwidth unit may be 2.5 MHz, for example. Two cases of 20 MHz and 40 MHz are illustrated at the top of FIG. 4, where one subband (SB) may represent 5 MHz or 2.5 MHz. For example, a 20 MHz subchannel 1 may be partitioned into 5 MHz, 10 MHz, and 5 MHz subbands. Subband 1 may have four spatial streams, as illustrated, and out of the four, streams 2 and 3 may be allocated to user 2, for example. One switch bit 404 may be assigned to the gap between any two adjacent subband units 402 as shown on the top of FIG. 4, for example. Accordingly, with a bandwidth of 80 MHz with 32 subband units, 31 bits may be needed. The switch bit 404 may indicate whether the two subband units by the gap are combined or separated. It should be noted, however, that the number of bandwidth units for each 20 MHz subchannel or the whole band can be any positive integer, for example, 9 units per 20 MHz.

For the frequency band partition, example systems, methods, and devices may use one switch bit 404 for each allocation unit 402 to indicate whether the unit stands alone or is combined with the adjacent unit. Four examples are illustrated in FIG. 4. In example 1 on the top, all subband units 402 may stand alone. Namely, the finest frequency allocation may be employed. In example 2 on the second row, all subband units 402 may be combined. Namely, the whole band with all 20 MHz subchannels may be allocated to one user as a whole piece or to more than one user with multiple spatial streams. By setting the switch bits, the band may be partitioned in to subbands that may have various number of subband units 406. It should be noted however that the switch bits indicating the gaps of a 20 MHz subchannel may be sent over the corresponding subchannel. This may allow devices only to operate at a single 20 MHz subchannel to detect the bandwidth partition of the subchannel, for example. In one example embodiment, the number of gaps may be less than the number of units by one, and the number of switch bits may be equal to the number of gaps. In one example embodiment, part of HE-SIGA or HE-SIG0 may be sent repeatedly over each 20 MHz subchannels, for example, and the rest may be sent over the entire band without repeating the content over the subchannels.

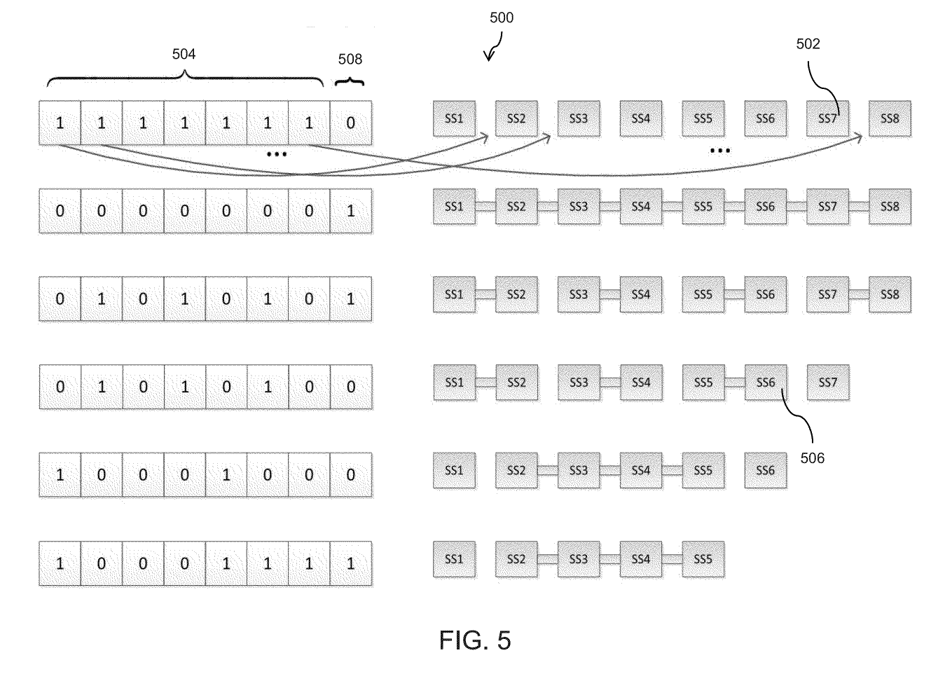

Illustrated in FIG. 5 is a spatial stream partition 500, where the disclosed systems, methods, and devices provide two designs, according to certain embodiments of the disclosure. The first design may be similar to that of frequency partition, such as that shown in FIG. 4, for example. One switch bit 504 per stream may be assigned to indicate whether the stream and adjacent streams 502 are assigned to the same user. The second design may have two parts, for example. First, the number of streams 506 per subband may be specified. Second, all the allocation combinations may be sequentially indexed. The second design may be particularly useful for the downlink MU-MIMO to send SIG bits in parallel over multiple spatial streams, where parallel transmissions can reduce the overhead time.

Two example schemes for indicating the spatial stream partition are depicted in FIG. 5, for example. In the frequency band partition, the total number of subband units per 20 MHz subchannel may be a known constant, for example. In contrast, the total number of spatial streams 506 for a given subband may be variable. Therefore, it may be necessary to indicate both the total number of streams 506 and the partition. There may be various ways to indicate this, and the one illustrated in FIG. 5 is just one example. Some designs may use 10 bits while some designs may only use 8 bits for a total of eight streams. Additionally, some designs may use 3 bits to indicate the total number of streams and 7 bits to indicate the partition of the streams.

According to one example embodiment, the maximum number of streams may be defined as Nₘₐₓ. The streams may be sequentially indexed from 0 to Nₘₐₓ₋₁ or 1 to Nₘₐₓ. This index order can match the order used in other parts of the system signaling, e.g. the order of the channel training signals of different streams, e.g. LTF order. Nₘₐₓ may be one of {4, 5, 6, 7, 8} with 8 likely being the maximum. Once Nₘₐₓ if defined, only Nₘₐₓ bits are required to indicate the partition of the streams and the total number of streams. The first Nₘₐₓ₋₁ bits may be switch bits 504 similar to those for bandwidth partition. The last bit, for example, Nₘₐₓ₋ₜₕ bit may be called termination bit 508. It may indicate the total number of streams 506. The last switch between 0 and 1 may indicate the last usable stream, for example. If the last switch happens between the (T−1)th and the T-th bits counting from the left in FIG. 5, the total number of available streams may be T.

Six examples are illustrated in FIG. 5, for example. In the example on the top, the first seven switch bits 504 may be set to 1. This may indicate that all the eight streams belong to eight different users. The very last termination bit 508 may be set to 0. This 0 and the last 1 jointly generate a switch between 0 and 1. This switch may indicate that the usable streams may terminate right after the eighth stream. In example 2 on the second row, for example, the first seven bits 504 may be set to 0. This may indicate that all the eight streams belong to one user. The termination bit 508 may be set to 1. This 1 and the last 0 may jointly generate a switch between 0 and 1. This switch may indicate that the usable streams terminate right after the eighth stream. The first switch bits work the same as in the bandwidth partition. The termination bit may indicate the total number of usable streams 506 as follows. If the termination bit is set to 1 (or 0), then we count how many consecutive 1s (or 0s) immediately before the termination bit on the left. The two examples are illustrated at the bottom of FIG. 5. In the last row, the termination bit may be set to 1 and there may be three consecutive 1s on the right immediately next to the termination bit. This indicates that the last three streams, for example, streams 6, 7, and 8, are not available. At the second last row of FIG. 5, the termination bit 508 may be set to 0 and there may be two consecutive 0s on the right immediately next to the termination bit. This may indicate that the last two streams, for example, streams 7 and 8, may be unavailable. In other words, the total number of usable streams may be six, which may be less than Nₘₐₓ for Nₘₐₓ=8.

The scheme illustrated in FIG. 5 may be used in the first part of the high efficiency SIG, for example, HE-SIG_{A} that may be broadcasted by the access point. Users can learn about the configuration of the spatial streams before estimating the beam-formed channel from the HE-LFTs. Since the HE-SIG_{A} is broadcasted by a single spatial stream, it may not be as efficient as the MIMO transmission of the second part of SIG, for example, HE-SIG_{B}. For reducing the overhead, HE-SIG_{A} may specify the total number of streams in each subband using 3 bits instead of 8 bits and HE-SIG_{B} may carry the partition of the streams. The HE-SIG_{B} may be usually beam-formed to the destination user, for example. The destination user first knows the total number of streams in the subband. Using the total number, the user may interpret for format of the HE-LTFs or HE-MTFs that are the training symbols for learning the beam-formed channels of the streams on the subband. After the beam-formed channels are learned, the user using the learned channels may decode the HE-SIG_{B} sent over the channels. The HE-SIG_{B} of the user may need to tell the user which streams belong to the user. According to one example embodiment, HE-SIGB, which may contain user specific information, may be sent after HE-SIGA and before HE-STF as shown in the upper portion of FIG. 3. In one embodiment, the transmission of HE-SIGB may be broadcasted without beamforming.

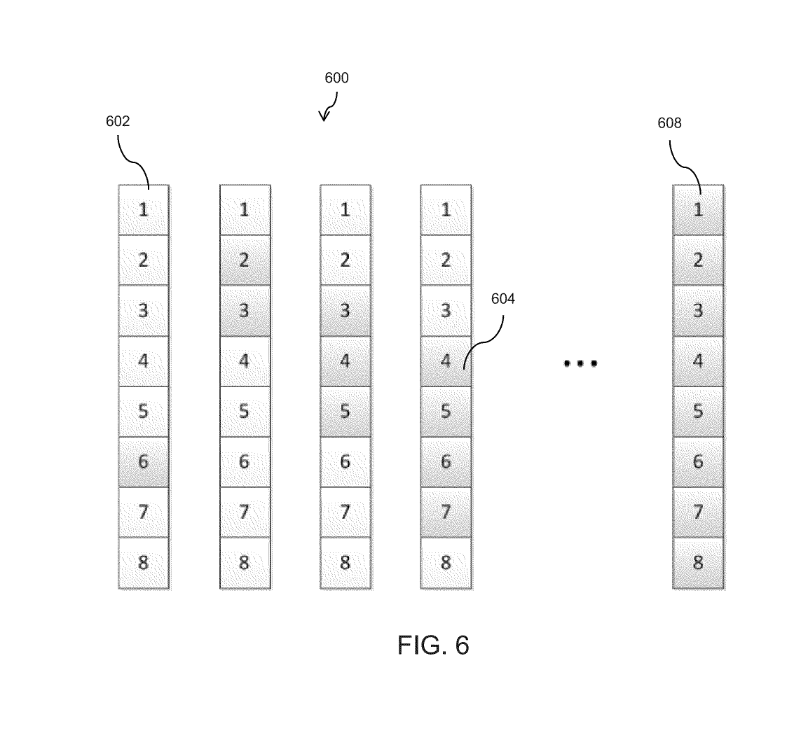

According to one or more example embodiments, the example systems, methods, and devices disclosed herein provide a scheme for the HE-SIG_{B} to indicate the streams of the destination user. In one example embodiment, the total number of streams may be denoted by N. Since N is already known from HE-SIG_{A}, all the combinations of the stream allocation for the N streams may be indexed. For reducing overhead with no performance degradation, a constrain may be placed in the standard that all the streams of the same user may have to be indexed by consecutive stream indexes 602 as shown in FIG. 6, for example. This may reduce the SIG overhead by a factor or two. The user can be assigned any number of streams 604 up to the total number of streams 608, as illustrated in FIG. 6, for example. As illustrated in this figure, the total number of streams 608 may be eight. The user can have any number of streams up to 8. Therefore, the scheme 600 may need eight indexes to indicate the combinations.

Similarly, when the user has two streams, for example, there may be seven combinations for the two streams that are adjacent. All the combinations may be summed up as

$$N + ( N - 1 ) + … + 1 = \frac{N ( N + 1 )}{2}$$

Accordingly,

$$Q = ⌈ {log}_{2} \frac{N ( N + 1 )}{2} ⌉$$

bits may be needed to indicate the stream allocation for the user where ┌ ┐ may be the ceiling function. For N=8, for example, 8 streams in total, at most 6 bits may be needed in the HE-SIG_{B}. If the total number of streams N is not specified beforehand, for example, in HE-SIG_{A}, then the total number of index entries may be calculated and the required number of bits for a self-contained indication may be

$$⌈ {log}_{2} {\sum }_{N = 1}^{{N}_{MAX}} \frac{N ( N + 1 )}{2} ⌉ ,$$

Where Nₘₐₓ is the maximum number of streams, for example, 8. For Nₘₐₓ₌₈ statically allocating only 7 bits may be needed for a varying N=1, 2, 3, . . . 8. The total number of combinations may be 121. Namely, the user may check the 7 bit index to find out what the number N may be and which streams out of the N streams are for the user. If N is sent by HE-SIGA, then only Q bits may be needed in HE-SIGB for the destination user. For a smaller N, the Q can be shorter, for example. For a shorter Q, HE-SIGB may also be shorter and thus get better protection for the same frequency, time, space resource. For example, the repetition of code bits (or code symbols) or a lower coding rate may be employed for enhancing the reliability for the shorter HE-SIGB. However, the self-contained method may enable a fixed length design for HE-SIGB and HE-SIGA that may, for example simplify the implementation logic.

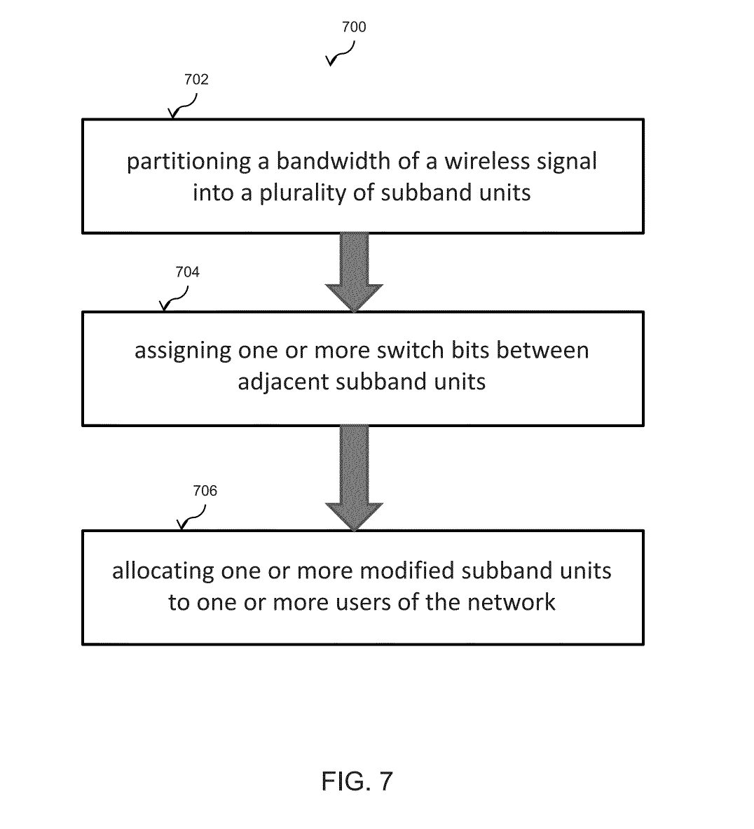

FIG. 7, for example, illustrates example operations that may be involved in a method 700 for indication of bandwidth allocation in a wireless network, according to one or example embodiments of the disclosure. At step 702, a network device may partition a bandwidth of a wireless signal into a plurality of subband units. At step 704, the network device may assign one or more switch bits between adjacent subband units. In one example embodiment, the formation of switch bit and bandwidth may be pre-defined. For example, in an OFDMA mode, 8 switch bits may be defined for the 9 allocation units of a 20 MHz channel at 2.4 GHz. In another example, for multiuser MIMO mode, 1 switch bit may be defined for two allocation units of 40 MHz channel at 5 GHz. The allocation unit of multiuser MIMO mode may be several times greater than that of the OFDMA mode. At step 706, the network device may allocate one or more modified subband units to one or more users of the network. The bandwidth of the wireless signal can be 20 MHz, 40 MHz, 80 MHz, or 160 MHz. The subband units may have a frequency of 2.03125 MHz, 4.0625 MHz, or 20 MHz. The method can also include transmitting to the one or more users, by the network device, the modified subband units over a corresponding subchannel.

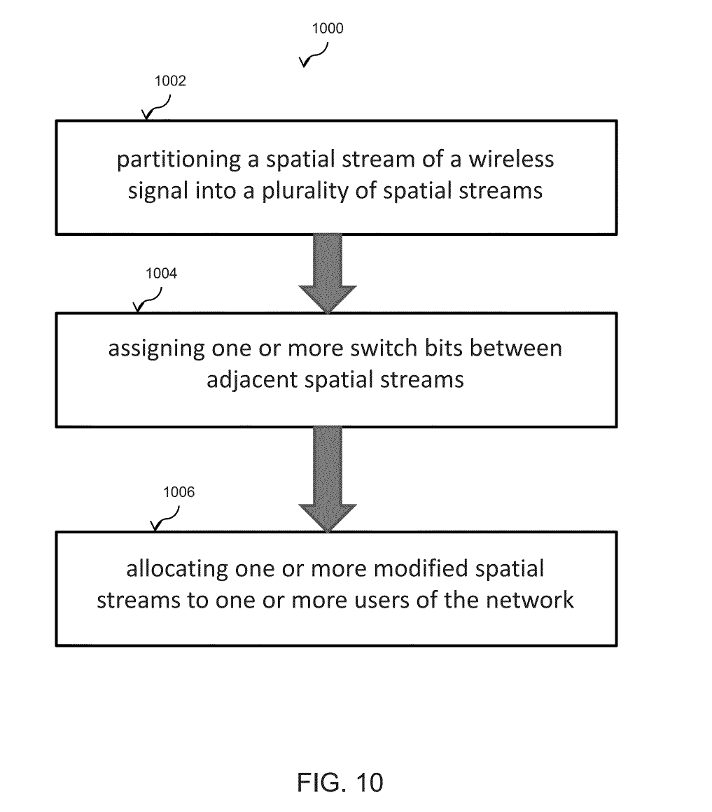

FIG. 10, for example, illustrates example operations that may be involved in a method 1000 for indication of stream allocation in a wireless network, according to one or example embodiments of the disclosure. At operation 1002, a network device may partition a spatial stream of a wireless signal into a plurality of spatial streams. At operation 1004, the network device may assign one or more switch bits between adjacent spatial streams. At operation 1006, the network device may allocate one or more modified spatial streams to one or more users of the network. The method may also include indexing, by the network device, the plurality of spatial streams in an order that matches a Long Training Field (LTF) order of the wireless signal. The plurality of switch bits may include a termination bit to determine a number of spatial streams. The method 1000 may further include generating, by the network device, a plurality of code bits to indicate stream allocation to the one or more users.

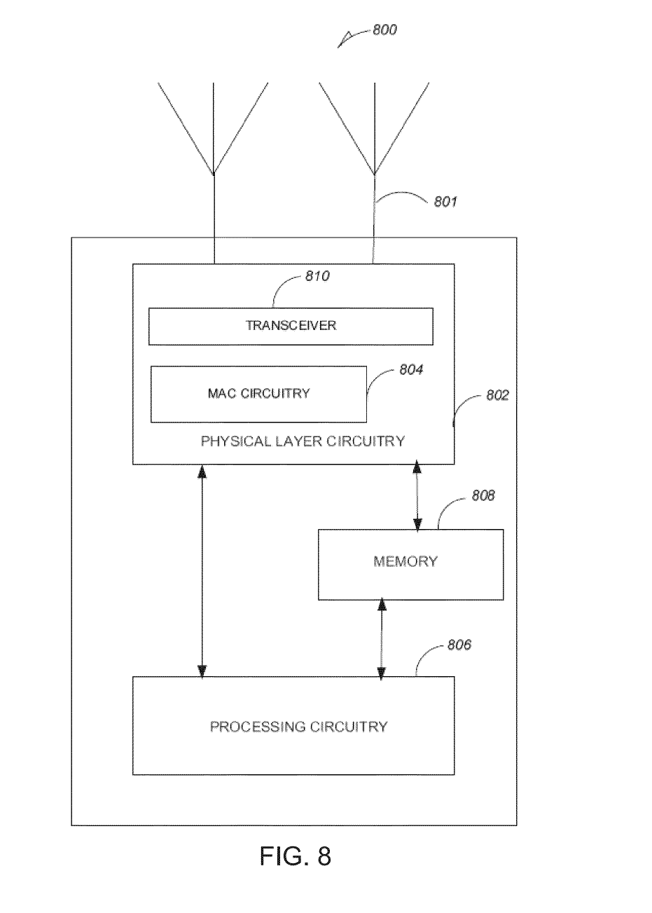

FIG. 8 shows a functional diagram of an exemplary communication station 800 in accordance with some embodiments of the disclosure. In one embodiment, FIG. 8 illustrates a functional block diagram of a communication station that may be suitable for use as an AP 102 (FIG. 1) or communication station STA 104 (FIG. 1) in accordance with some embodiments. The communication station 800 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 800 may include physical layer circuitry 802 having a transceiver 810 for transmitting and receiving signals to and from other communication stations using one or more antennas 801. The physical layer circuitry 802 may also include medium access control (MAC) circuitry 804 for controlling access to the wireless medium. The communication station 800 may also include processing circuitry 806 and memory 808 arranged to perform the operations described herein. In some embodiments, the physical layer circuitry 802 and the processing circuitry 806 may be configured to perform operations detailed in FIGS. 2-6.

In accordance with some embodiments, the MAC circuitry 804 may be arranged to contend for a wireless medium and configure frames or packets for communicating over the wireless medium and the physical layer circuitry 802 may be arranged to transmit and receive signals. The physical layer circuitry 802 may include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the physical layer circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device may, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

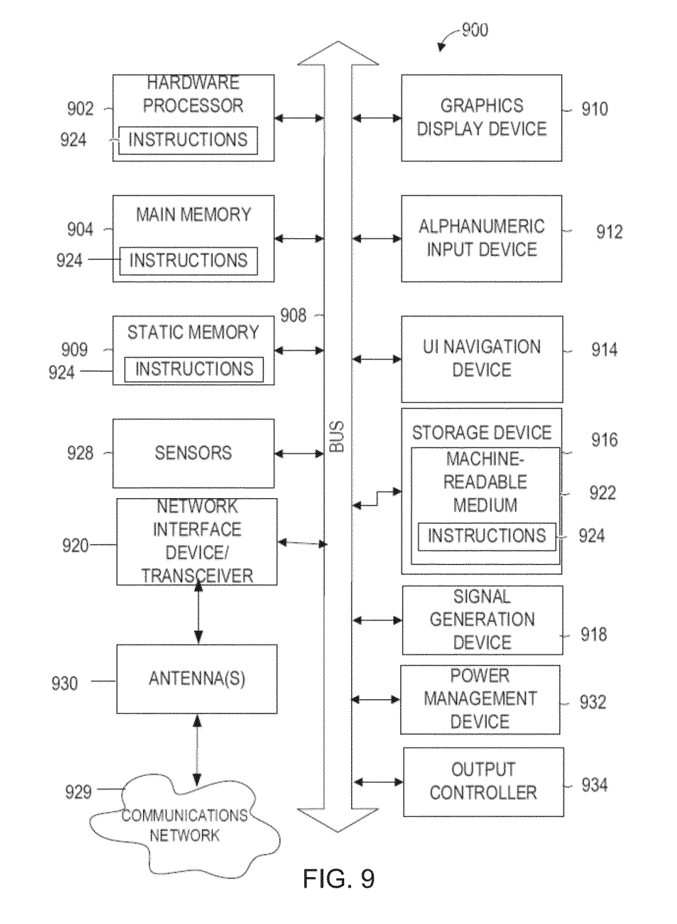

FIG. 9 illustrates a block diagram of an example of a machine 900 or system upon which any one or more of the techniques (e.g., methodologies) discussed herein may be performed according to certain embodiments of the disclosure. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912 and UI navigation device 914 may be a touch screen display. The machine 900 may additionally include a storage device (i.e., drive unit) 916, a signal generation device 918 (e.g., a speaker), a network interface device/transceiver 920 coupled to antenna(s) 930, and one or more sensors 928, such as a global positioning system (GPS) sensor, compass, accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium includes a machine readable medium with a plurality of particles having resting mass. Specific examples of massed machine readable media may include: non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible media to facilitate communication of such software.

### Example Embodiments

One example embodiment is a method for indication of bandwidth allocation in a wireless network. The method may include partitioning, by a network device, a bandwidth of a wireless signal into a plurality of subband units, assigning, by the network device, one or more switch bits between adjacent subband units, and allocating, by the network device, one or more modified subband units to one or more users of the network. The bandwidth of the wireless signal can be 20 MHz, 40 MHz, 80 MHz, or 160 MHz. The subband units may have a frequency of 2.03125 MHz, 4.0325 MHz, or 20 MHz. The method can also include transmitting to the one or more users, by the network device, the modified subband units over a corresponding subchannel.

Another example embodiment is a device for indication of bandwidth allocation in a wireless network. The device may include physical layer circuitry, one or more antennas, at least one memory, and one or more processing elements for partitioning a bandwidth of a wireless signal into a plurality of subband units, assigning one or more switch bits between adjacent subband units, and allocating one or more modified subband units to one or more users of the network. The bandwidth of the wireless signal may be 20 MHz, 40 MHz, 80 MHz, or 160 MHz. The subband units may have a frequency of 2.03125 MHz, 4.0325 MHz, or 20 MHz. The modified subband units can be transmitted to the one or more users over a corresponding subchannel.

Another example embodiment is a non-transitory computer readable storage device including instructions stored thereon, which when executed by one or more processor(s) of a network device, cause the network device to perform operations of partitioning a bandwidth of a wireless signal into a plurality of subband units, assigning one or more switch bits between adjacent subband units, and allocating one or more modified subband units to one or more users of a wireless network. The bandwidth of the wireless signal may be 20 MHz, 40 MHz, 80 MHz, or 160 MHz. The subband units may have a frequency of 2.03125 MHz, 4.0325 MHz, or 20 MHz. The modified subband units may be transmitted to the one or more users over a corresponding subchannel.

Another example embodiment is a method for indication of stream allocation in a wireless network. The method may include partitioning, by a network device, a spatial stream of a wireless signal into a plurality of spatial streams, assigning, by the network device, one or more switch bits between adjacent spatial streams, and allocating, by the network device, one or more modified spatial streams to one or more users of the network. The method may also include indexing, by the network device, the plurality of spatial streams in an order that matches a Long Training Field (LTF) order of the wireless signal. The plurality of switch bits may include a termination bit to determine a number of spatial streams. The method may further include generating, by the network device, a plurality of code bits to indicate stream allocation to the one or more users.

Another example embodiment is a device for indication of stream allocation in a wireless network. The device may include physical layer circuitry, one or more antennas, at least one memory, and one or more processing elements for partitioning a spatial stream of a wireless signal into a plurality of spatial streams, assigning one or more switch bits between adjacent spatial streams, and allocating one or more modified spatial streams to one or more users of the network. The plurality of spatial streams may be indexed in an order that matches a Long Training Field (LTF) order of the wireless signal. The plurality of switch bits may include a termination bit to determine a number of spatial streams. The network device may generate a plurality of code bits to indicate stream allocation to the one or more users.

Another example embodiment is a non-transitory computer readable storage device including instructions stored thereon, which when executed by one or more processor(s) of a network device, cause the network device to perform operations of partitioning a spatial stream of a wireless signal into a plurality of spatial streams, assigning one or more switch bits between adjacent spatial streams, and allocating one or more modified spatial streams to one or more users of a wireless network. The plurality of spatial streams are indexed in an order that matches a Long Training Field (LTF) order of the wireless signal. The plurality of switch bits include a termination bit to determine a number of spatial streams. The network device may generate a plurality of code bits to indicate stream allocation to the one or more users.

While there have been shown, described and pointed out, fundamental novel features of the disclosure as applied to the exemplary embodiments thereof, it will be understood that various omissions and substitutions and changes in the form and details of devices illustrated, and in their operation, may be made by those skilled in the art without departing from the spirit of the disclosure. Moreover, it is expressly intended that all combinations of those elements and/or method operations, which perform substantially the same function in substantially the same way to achieve the same results, are within the scope of the disclosure. Moreover, it should be recognized that structures and/or elements and/or method operations shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. A method for indication of bandwidth allocation in a wireless network, the method comprising:
partitioning, by a network device, a bandwidth of a wireless signal into a plurality of subband units;
assigning, by the network device, one or more switch bits between adjacent subband units; and
allocating, by the network device, one or more modified subband units to one or more users of the network.

2. The method of claim 1, wherein the bandwidth of the wireless signal is 20 MHz, 40 MHz, 80 MHz, or 160 MHz.

3. The method of claim 1, wherein the subband units have a frequency of 2.03125 MHz, 4.0325 MHz, or 20 MHz.

4. The method of claim 1, further comprising:
transmitting to the one or more users, by the network device, the modified subband units over a corresponding subchannel.

5. A device for indication of bandwidth allocation in a wireless network, the device comprising:
at least one memory comprising computer-executable instructions stored thereon; and
one or more processing elements to execute the computer-executable instructions for:
partitioning a bandwidth of a wireless signal into a plurality of subband units;
assigning one or more switch bits between adjacent subband units; and
allocating one or more modified subband units to one or more users of the network.

6. The device of claim 5, wherein the bandwidth of the wireless signal is 20 MHz, 40 MHz, 80 MHz, or 160 MHz.

7. The device of claim 5, wherein the subband units have a frequency of 2.03125 MHz, 4.0325 MHz, or 20 MHz.

8. The device of claim 5, wherein the modified subband units are transmitted to the one or more users over a corresponding subchannel.

9. A non-transitory computer readable storage device including instructions stored thereon, which when executed by one or more processor(s) of a network device, cause the network device to perform operations of:
partitioning a bandwidth of a wireless signal into a plurality of subband units;
assigning one or more switch bits between adjacent subband units; and
allocating one or more modified subband units to one or more users of a wireless network.

10. The storage device of claim 9, wherein the bandwidth of the wireless signal is 20 MHz, 40 MHz, 80 MHz, or 160 MHz.

11. The storage device of claim 9, wherein the subband units have a frequency of 2.03125 MHz, 4.0325 MHz, or 20 MHz.

12. The storage device of claim 9, wherein the modified subband units are transmitted to the one or more users over a corresponding subchannel.

13. A method for indication of stream allocation in a wireless network, the method comprising:
partitioning, by a network device, a spatial stream of a wireless signal into a plurality of spatial streams;
assigning, by the network device, one or more switch bits between adjacent spatial streams; and
allocating, by the network device, one or more modified spatial streams to one or more users of the network.

14. The method of claim 13, further comprising:
indexing, by the network device, the plurality of spatial streams in an order that matches a Long Training Field (LTF) order of the wireless signal.

15. The method of claim 13, wherein the plurality of switch bits include a termination bit to determine a number of spatial streams.

16. The method of claim 13, further comprising:
generating, by the network device, a plurality of code bits to indicate stream allocation to the one or more users.

17. A device for indication of stream allocation in a wireless network, the device comprising:
at least one memory comprising computer-executable instructions stored thereon; and
one or more processing elements to execute the computer-executable instructions for:
partitioning a spatial stream of a wireless signal into a plurality of spatial streams;
assigning one or more switch bits between adjacent spatial streams; and
allocating one or more modified spatial streams to one or more users of the network.

18. The device of claim 17, wherein the plurality of spatial streams are indexed in an order that matches a Long Training Field (LTF) order of the wireless signal.

19. The device of claim 17, wherein the plurality of switch bits include a termination bit to determine a number of spatial streams.

20. The device of claim 17, wherein the network device generates a plurality of code bits to indicate stream allocation to the one or more users.

21. A non-transitory computer readable storage device including instructions stored thereon, which when executed by one or more processor(s) of a network device, cause the network device to perform operations of:
partitioning a spatial stream of a wireless signal into a plurality of spatial streams;
assigning one or more switch bits between adjacent spatial streams; and
allocating one or more modified spatial streams to one or more users of a wireless network.

22. The storage device of claim 21, wherein the plurality of spatial streams are indexed in an order that matches a Long Training Field (LTF) order of the wireless signal.

23. The storage device of claim 21, wherein the plurality of switch bits include a termination bit to determine a number of spatial streams.

24. The storage device of claim 21, wherein the network device generates a plurality of code bits to indicate stream allocation to the one or more users.
